(19) United States
(12) Patent Application Publication
(10) Pub. No.: US 2019/0177674 A1
(43) Pub. Date: Jun. 13, 2019

(54) SYSTEMS, METHODS, AND COMPOSITIONS OF BLENDED CANNABINOID ENRICHED BEVERAGES

(71) Applicant: CBD Spirits, LLC, Danville, CA (US)

(72) Inventors: Michael Jeffrey Montgomery, Pacific Palisades, CA (US); Andrew T. Brown, West Hills, CA (US); Jesse Clay McKnight, III, Danville, CA (US); John Alden Pierce, Redondo Beach, CA (US); Christopher James Macaluso, Lexington, KY (US); Grondall Gene Potter, II, Elkhorn City, KY (US); James Ernest Arnett, Louisville, KY (US)

(21) Appl. No.: 16/212,526

(22) Filed: Dec. 6, 2018

Related U.S. Application Data
(60) Provisional application No. 62/597,347, filed on Dec. 11, 2017.

(51) Int. Cl. C12G 3/055; B01F 11/02; B01F 13/00; B01F 3/04

(52) U.S. Cl. CPC C12G 3/055; B01F 11/02; B01F 2215/007; B01F 3/04099; B01F 2003/04921; B01F 13/0059

(57) ABSTRACT

Systems, methods, and compositions of blended beverages are provided herein. Exemplary compositions are a blended beverage including a cannabidiol (CBD) crystalline isolate suspended in an alcoholic beverage, the alcoholic CBD beverage being a concentration of least 20 milligrams of CBD crystalline isolate per cubic centimeter of the beverage. In various embodiments the alcoholic CBD beverage is a wine, a spirit, or a beer.

### CROSS REFERENCE TO RELATED APPLICATIONS

This patent application claims the benefit of U.S. Provisional Patent Application Ser. No. 62/597,347, filed on Dec. 11, 2017, entitled “CBD Wine,” which is hereby incorporated in its entirety including all references and appendices cited therein.

### FIELD OF THE INVENTION

The present technology of this application is directed generally to blended beverages, and more specifically, but not by way of limitation, to systems, methods, and compositions of cannabinoid enriched blended beverages.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

In various exemplary embodiments of the present technology include methods for preparing blended beverages. Various exemplary methods include dissolving a cannabinoid oil into an ethanol based liquid, the ethanol based liquid being at least 95 percent Alcohol By Volume (ABV) to produce an emulsion of the cannabinoid oil in the at least 95 percent ABV ethanol; and heating the emulsion of the cannabinoid oil in the at least 95 percent ABV ethanol to between 100 degrees Fahrenheit and 160 degrees Fahrenheit, the heating of the emulsion resulting in the cannabinoid oil dissolving in the at least 95 percent ABV ethanol.

In some embodiments the cannabinoid oil is a hemp phytocannabinoid, the hemp phytocannabinoid occurring naturally in a hemp plant. In some instances the hemp phytocannabinoid is cannabidiol (CBD).

In various embodiments the methods further comprise preparing the cannabinoid oil by refining a hemp plant using at least one of chromatographic separation, distillation, and selective membrane filtration.

In some embodiments the methods further comprise preparing the cannabinoid oil by crude extraction from a hemp plant, the crude extraction from the hemp plant comprising removing plant material from the hemp plant.

In various embodiments the methods further comprise high shear mixing of the emulsion of the cannabinoid oil dissolved in the at least 95 percent ABV ethanol based liquid. In some instances the the high shear mixing comprises dispersing the emulsion of the cannabinoid oil in the at least 95 percent ABV ethanol using an array of rotors and stators to produce a dispersed emulsion of the cannabinoid oil in the at least 95 percent ABV ethanol.

In some embodiments methods further comprise sonicating the dispersed emulsion of the cannabinoid oil in the at least 95 percent ABV ethanol using an ultrasonic homogenizer; and bubbling nitrogen gas into the dispersed emulsion of the cannabinoid oil in the at least 95 percent ABV ethanol, the bubbling of the nitrogen gas preventing oxygen degradation of the dispersed emulsion of the cannabinoid oil in the at least 95 percent ABV ethanol.

In various embodiments the methods include microfluidizer high shear fluid processing of the emulsion of the cannabinoid oil in the at least 95 percent ABV ethanol.

Various exemplary methods include heating a crystallized powder cannabinoid compound to at least 155 degrees Fahrenheit, the heating of the crystallized powder cannabinoid resulting in melting of the crystallized powder cannabinoid; and dissolving the melted crystallized powder cannabinoid compound into an ethanol based liquid, the ethanol based liquid being at least 95 percent Alcohol By Volume (ABV) to produce a suspension of the melted crystallized powder cannabinoid compound in the at least 95 percent ABV ethanol.

In various embodiments the crystallized powder cannabinoid compound is a hemp phytocannabinoid, the hemp phytocannabinoid occurring naturally in a hemp plant. In some instances the hemp phytocannabinoid is a cannabidiol (CBD) crystalline isolate.

In some embodiments methods comprise high shear mixing of the suspension of the crystallized powder cannabinoid compound dissolved in the at least 95 percent ABV ethanol based liquid; and bubbling nitrogen gas into the suspension of the crystallized powder cannabinoid compound dissolved in the at least 95 percent ABV ethanol based liquid, the bubbling of the nitrogen gas preventing oxygen degradation of the suspension of the crystallized powder cannabinoid compound dissolved in the at least 95 percent ABV ethanol based liquid.

In various embodiments the high shear mixing comprises dispersing the suspension of the crystallized powder cannabinoid compound dissolved in the at least 95 percent ABV ethanol based liquid using an array of rotors and stators to produce a homogenized suspension of the crystallized powder cannabinoid compound in the at least 95 percent ABV ethanol.

In some embodiments methods comprise adding the homogenized suspension of the crystallized powder cannabinoid compound in the at least 95 percent ABV ethanol to an alcoholic beverage. In some instances the alcoholic beverage is at least one of a wine, a spirit, and a beer.

In various embodiments the alcoholic beverage is a concentration of at least 20 milligrams of the crystallized powder cannabinoid compound per cubic centimeter of the beverage.

In some embodiments the alcoholic beverage is a concentration of at least 25 milligrams of the crystallized powder cannabinoid compound per cubic centimeter of the beverage.

Some exemplary compositions include a blended beverage including a cannabidiol (CBD) alcoholic beverage comprising a fermented alcoholic beverage with an ethyl alcohol content ranging between 2 percent Alcohol By Volume (ABV) and 20 percent ABV; and cannabinoid being present a concentration between 00.01 milligrams (mg) per milliliter (mL) and 10.00 mg per mL.

In various embodiments the cannabinoid is at least one of an acid form comprising Cannabigerolic acid (CBGA), Δ9-tetrahydrocannabinolic acid (THCA), Cannabidiolic acid (CBDA), Cannabichromenenic acid (CBCA), Cannabigerovarinic acid (CBGVA), Tetrahydrocanabivarinic acid (THCVA), Cannabidivarinic acid (CBDVA), and Cannabichromevarinic acid (CBCVA), and an decarboxylated form comprising Cannabigerol (CBG), Δ9-tetrahydrocannabinol (THC), Cannabidiol (CBD), Cannabichromene (CBC), Cannabigerivarin (CBGV), Tetrahydrocannabivarin (THCV), Cannabidivarin (CBDV), and Cannabichromevarin (CBCV).

In some embodiments the fermented alcoholic beverage is at least one of beer, mead, cider, wine, port, and fortified wine.

In various embodiments the cannabinoid is cannabidiol (CBD).

Various exemplary compositions include a cannabinoid enriched alcoholic beverage, comprising a distilled alcoholic beverage with an ethyl alcohol content ranging between 42 percent Alcohol By Volume (ABV) and 90 percent ABV; and cannabinoid being present a concentration between 00.01 milligrams (mg) per milliliter (mL) and 10.00 mg per mL.

In some embodiments the cannabinoid is at least one of an acid form comprising Cannabigerolic acid (CBGA), Δ9-tetrahydrocannabinolic acid (THCA), Cannabidiolic acid (CBDA), Cannabichromenenic acid (CBCA), Cannabigerovarinic acid (CBGVA), Tetrahydrocanabivarinic acid (THCVA), Cannabidivarinic acid (CBDVA), and Cannabichromevarinic acid (CBCVA), and an decarboxylated form comprising Cannabigerol (CBG), Δ9-tetrahydrocannabinol (THC), Cannabidiol (CBD), Cannabichromene (CBC), Cannabigerivarin (CBGV), Tetrahydrocannabivarin (THCV), Cannabidivarin (CBDV), and Cannabichromevarin (CBCV).

In various embodiments the distilled alcoholic beverage is at least one of bourbon, whiskey, tequila, brandy, scotch, liqueur, absinthe, and moonshine.

In some embodiments the cannabinoid is cannabidiol (CBD). Other features, examples, and embodiments are described below.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a simplified diagram depicting a method for dissolving a cannabinoid oil into an ethanol based liquid according to embodiments of the present technology.

FIG. 2 is a simplified diagram showing a method for dissolving a crystallized powder cannabinoid compound into an ethanol based liquid according to embodiments of the present technology.

FIG. 3 is a table showing a range of doses for adding hemp oil and hemp isolate to a bottle of wine according to embodiments of the present technology.

FIG. 4 is a table showing a range of doses for adding hemp oil and hemp isolate to a glass of wine according to embodiments of the present technology.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Various embodiments of the present technology include merging an alcoholic beverage with hemp cannabidiol (CBD). Unlike cannabis CBD, hemp CBD has no psychoactive or euphoric effects. Alcoholic beverages combined with hemp CBD include all types of alcoholic beverages including any varietal of wine, sparkling wine, beer, hard liquor, cocktails, mixed drinks, and the like. Although, cannabis-based CBD or synthetic CBD may be merged with an alcoholic beverage, embodiments of the present technology focus on hemp based CBD. In some instances hemp based CBD is preferred to cannabis-based CBD or synthetic CBD. In various embodiments cannabis-based CBD or synthetic CBD that has a tetrahydrocannabinol (THC) level low enough as to not offer any psychoactive or euphoric effects is combined with an alcoholic beverage.

Embodiments of the present technology include a CBD alcoholic beverage with no discernable taste or flavor difference from the alcoholic beverage without CBD. For example, a CBD wine has the same taste, nose (scent) and viscosity a wine without CBD and is consistent with each varietal. For instance, a CBD wine has no discoloration.

In various embodiments a combination of alcohol and CBD creates a new composition. Alone, an alcoholic beverage and CBD have various effects on the human body. Together, an alcoholic beverage and CBD blend to create a CBD alcoholic beverage that offers a consumer with unique benefits of body, mind and spirit.

Some embodiments of CBD alcoholic beverages result in various effects for a consumer. Various effects for a consumer include a decrease in hangovers for a consumer. For example, a CBD to wine may reduce blood sugar following ingestion, leading to decreased occurrence of a hangover for a consumer. Moreover, CBD is a natural anti-inflammatory that further decreases a sensation of a hangover for a consumer. Various effects for a consumer include decreased nausea or vomiting. For example, CBD has anti-emetic properties that reduce a feeling of nausea and vomiting for a consumer. Various effects for a consumer include relaxation. For example, CBD wine results in enhanced relaxation for a consumer and CBD has anti-anxiety, anti-depressant effects for a consumer.

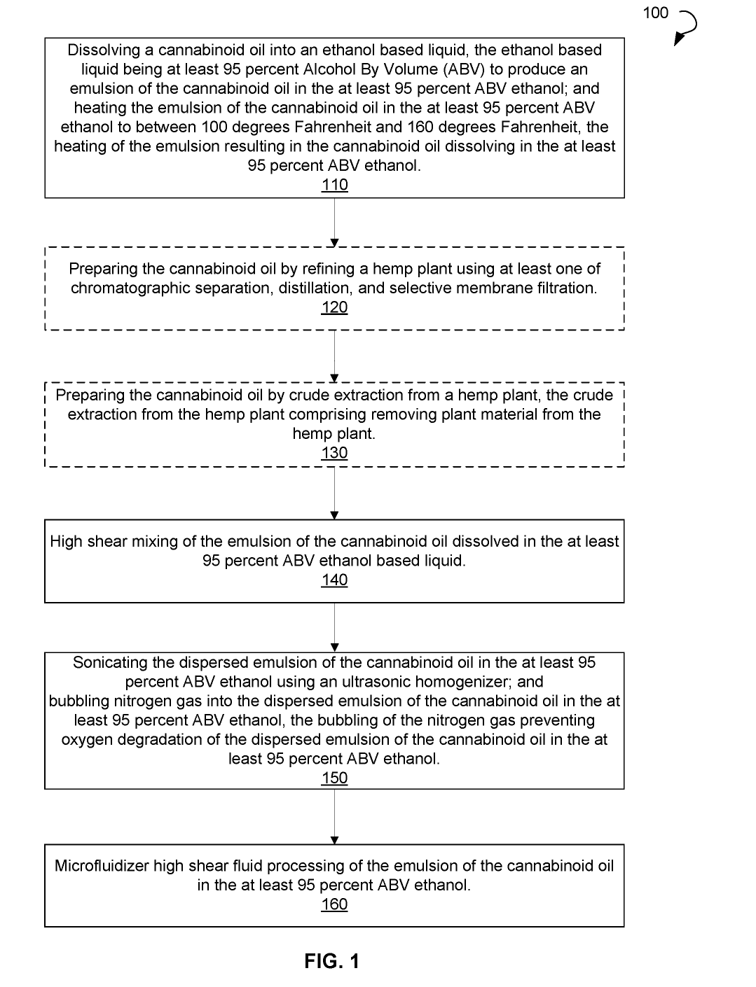

FIG. 1 is a simplified diagram 100 depicting a method for dissolving a cannabinoid oil into an ethanol based liquid according to embodiments of the present technology. FIG. 1 shows a method for preparing blended beverages. The method of FIG. 1 includes dissolving 110 a cannabinoid oil into an ethanol based liquid, the ethanol based liquid being at least 95 percent Alcohol By Volume (ABV) to produce an emulsion of the cannabinoid oil in the at least 95 percent ABV ethanol; and heating the emulsion of the cannabinoid oil in the at least 95 percent ABV ethanol to between 100 degrees Fahrenheit and 160 degrees Fahrenheit, the heating of the emulsion resulting in the cannabinoid oil dissolving in the at least 95 percent ABV ethanol.

In various embodiments the cannabinoid oil is a hemp phytocannabinoid, the hemp phytocannabinoid occurring naturally in a hemp plant. In some embodiments, the hemp phytocannabinoid is cannabidiol (CBD). For example, hemp CBD has beneficial effects for a consumer. Although cannabis-based CBD or synthetic CBD may be used with embodiments of the present technology.

FIG. 1 further show shows an optional step of preparing 120 the cannabinoid oil by refining a hemp plant using at least one of chromatographic separation, distillation, and selective membrane filtration. Additionally, the method includes an optional step of preparing 130 the cannabinoid oil by crude extraction from a hemp plant, the crude extraction from the hemp plant comprising removing plant material from the hemp plant.

The method of FIG. 1 additionally shows high shear mixing 140 of the emulsion of the cannabinoid oil dissolved in the at least 95 percent ABV ethanol based liquid. In various embodiments the high shear mixing comprises dispersing the emulsion of the cannabinoid oil in the at least 95 percent ABV ethanol using an array of rotors and stators to produce a dispersed emulsion of the cannabinoid oil in the at least 95 percent ABV ethanol. In some instances high shear mixing is done with a device such as a Ross High Shear Mixer, including a rotor/stator assembly, and the like. In various embodiments, the Ross High Shear Mixer is run at about 10,000 RPM for a period of time of 30 minutes to 60 minutes and the CBD solution or the melted CBD is introduced into the beverage and mixed while the temperature is maintained at a value from about 100 degrees Fahrenheit to 160 degrees Fahrenheit.

Some exemplary methods include mechanical mixing with a blade using a Bermixer device, and the like. In some instances mixing with the Bermixer is sustained for a time range of 30 minutes to 60 minutes at a constant temperature of 100 degrees Fahrenheit to 160 degrees Fahrenheit.

The method of FIG. 1 furthermore shows sonicating 150 the dispersed emulsion of the cannabinoid oil in the at least 95 percent ABV ethanol using an ultrasonic homogenizer; and bubbling nitrogen gas into the dispersed emulsion of the cannabinoid oil in the at least 95 percent ABV ethanol, the bubbling of the nitrogen gas preventing oxygen degradation of the dispersed emulsion of the cannabinoid oil in the at least 95 percent ABV ethanol. In some embodiments the ultrasonic homogenizer is an Ultrasonic probe or “Barbell” in a reaction chamber such as that from Industrial Sonomechanics or Hielscher. For example, the dispersed emulsion of the cannabinoid oil in the at least 95 percent ABV ethanol may be pumped through a “reaction cell” that contains the ultrasonic element that imparts energy and displacement (e.g., between about 20 kHz to about 40 kHz and displacement of about 70 microns) to make smaller particles to produce an equally dispersed emulsion of the cannabinoid oil in the at least 95 percent ABV ethanol throughout the beverage.

The method of FIG. 1 furthermore shows microfluidizer high shear fluid processing of the emulsion of the cannabinoid oil in the at least 95 percent ABV ethanol. For example, microfluidizer high shear fluid processing may be accomplished using high pressure homogenization using an apparatus by Microfluidics or an equivalent. For instance, the emulsion of the cannabinoid oil in the at least 95 percent ABV ethanol may be passed through a device (e.g., apparatus by Microfluidics) that imparts energy to reduce particle size of CBD in the emulsion of the cannabinoid oil in the at least 95 percent ABV ethanol to below 10 microns and in the range of about 10 nm to about 200 nm.

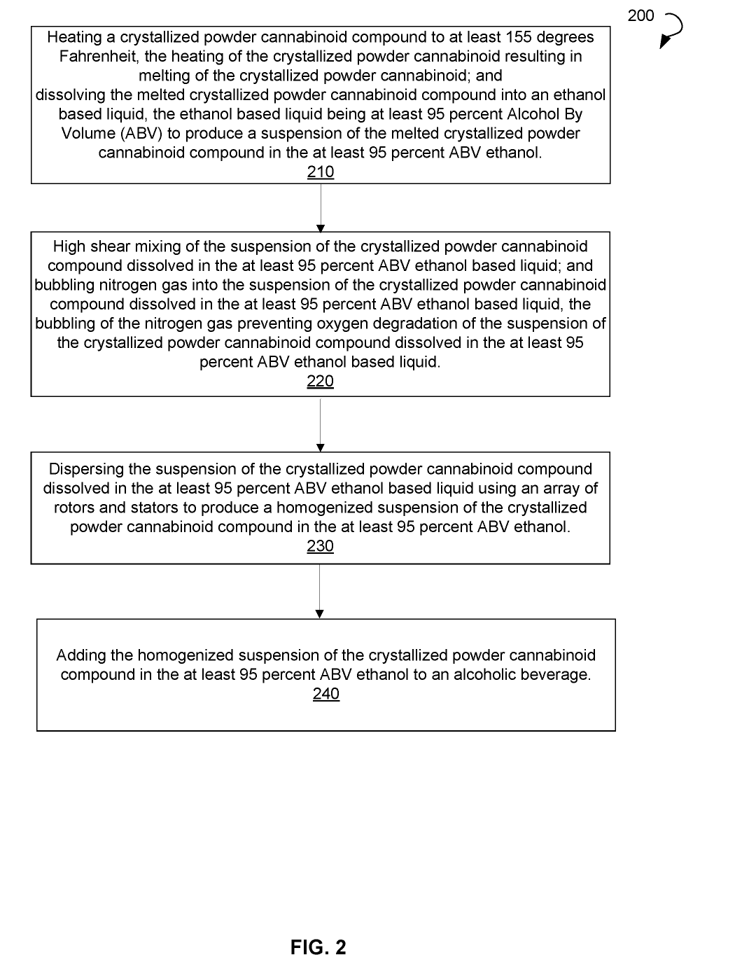

FIG. 2 is a simplified diagram 200 showing a method for dissolving a crystallized powder cannabinoid compound into an ethanol based liquid according to embodiments of the present technology. FIG. 2 shows a method for preparing blended beverages. The method of FIG. 2 includes heating 210 a crystallized powder cannabinoid compound to at least 155 degrees Fahrenheit, the heating of the crystallized powder cannabinoid resulting in melting of the crystallized powder cannabinoid; and dissolving the melted crystallized powder cannabinoid compound into an ethanol based liquid, the ethanol based liquid being at least 95 percent Alcohol By Volume (ABV) to produce a suspension of the melted crystallized powder cannabinoid compound in the at least 95 percent ABV ethanol.

In various embodiments the crystallized powder cannabinoid compound is a hemp phytocannabinoid, the hemp phytocannabinoid occurring naturally in a hemp plant. In some embodiments the hemp phytocannabinoid is a cannabidiol (CBD) crystalline isolate. For example, hemp CBD has beneficial effects for a consumer. Although cannabis-based CBD or synthetic CBD may be used with embodiments of the present technology.

FIG. 2 further shows high shear mixing 220 of the suspension of the crystallized powder cannabinoid compound dissolved in the at least 95 percent ABV ethanol based liquid; and bubbling nitrogen gas into the suspension of the crystallized powder cannabinoid compound dissolved in the at least 95 percent ABV ethanol based liquid, the bubbling of the nitrogen gas preventing oxygen degradation of the suspension of the crystallized powder cannabinoid compound dissolved in the at least 95 percent ABV ethanol based liquid.

FIG. 2 additionally shows high shear mixing of the suspension of the crystallized powder cannabinoid compound dissolved in the at least 95 percent ABV ethanol based liquid. In various embodiments the high shear mixing comprises dispersing 230 the suspension of the crystallized powder cannabinoid compound dissolved in the at least 95 percent ABV ethanol based liquid using an array of rotors and stators to produce a homogenized suspension of the crystallized powder cannabinoid compound in the at least 95 percent ABV ethanol.

FIG. 2 additionally further shows adding 240 the homogenized suspension of the crystallized powder cannabinoid compound in the at least 95 percent ABV ethanol to an alcoholic beverage, wherein the beverage is a concentration of at least 20 milligrams of the crystallized powder cannabinoid compound per cubic centimeter of the beverage. In various embodiments the alcoholic beverage is at least one of a wine, a spirit, and a beer, and the like. In some embodiments the alcoholic beverage is a concentration of at least 20 milligrams of the crystallized powder cannabinoid compound per cubic centimeter of the beverage. In various embodiments the alcoholic beverage is a concentration of at least 25 milligrams of the crystallized powder cannabinoid compound per cubic centimeter of the beverage.

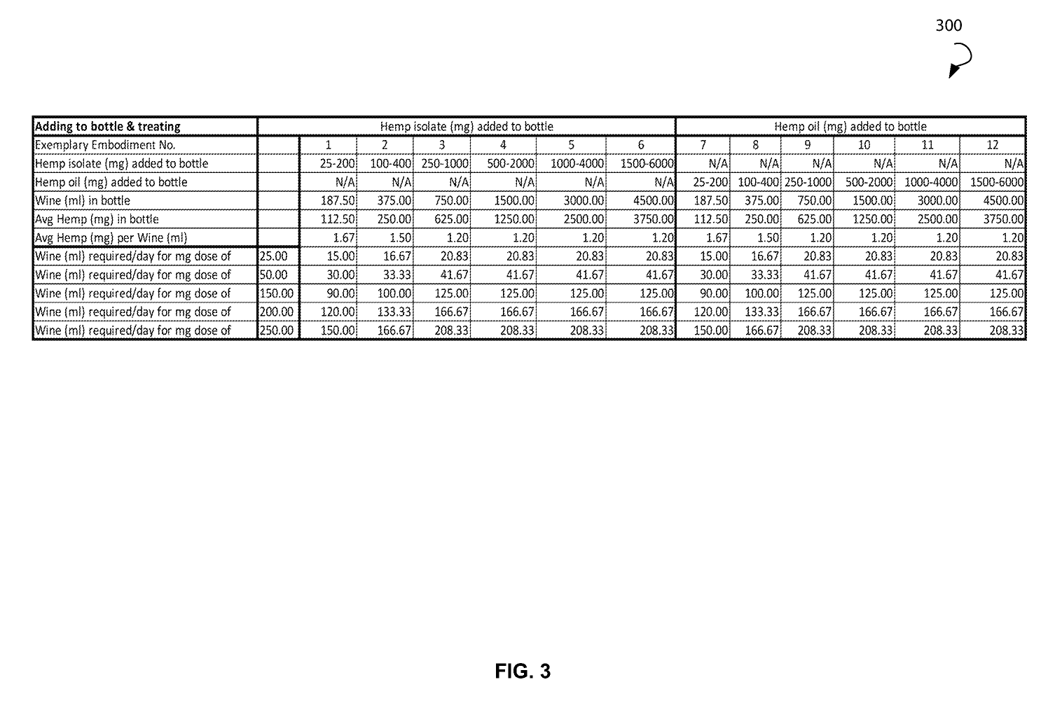

FIG. 3 is a table 300 showing a range of doses for adding hemp oil and hemp isolate to a bottle of wine according to embodiments of the present technology. Table 300 of FIG. 3 shows ratios for precise amounts of hemp cannabidiol isolate (CBD isolate) added to each wine bottle in exact amounts (by weight) prior to the filling of each bottle with 750 mL of wine. Due to the addition of CBD isolate prior to the addition of liquid to bottles, the CBD mixes and dissolves into the wine in amounts proportional to the amounts offered per bottle of wine (measured in milligrams). Hemp CBD is also available in non-isolate formulations, such as an oil formulation, though such a CBD product are only added to liquids via carefully measured drops in each glass of wine to ensure proper dosing. As hemp CBD oil is, in fact, an oil, it will not mix appropriately in proportionate amounts when added to alcohol, thereby creating the possibility of uneven dosing (which could lead to the possibility of too little or too much CBD per glass). Embodiments of the present technology avoid one glass receiving, for example, 500 mg and the other glasses poured from the same bottle receiving zero milligrams of CBD. Table 300 of FIG. 3 also shows a volume of CBD wine that a consumer must drink to receive a desired CBD dose.

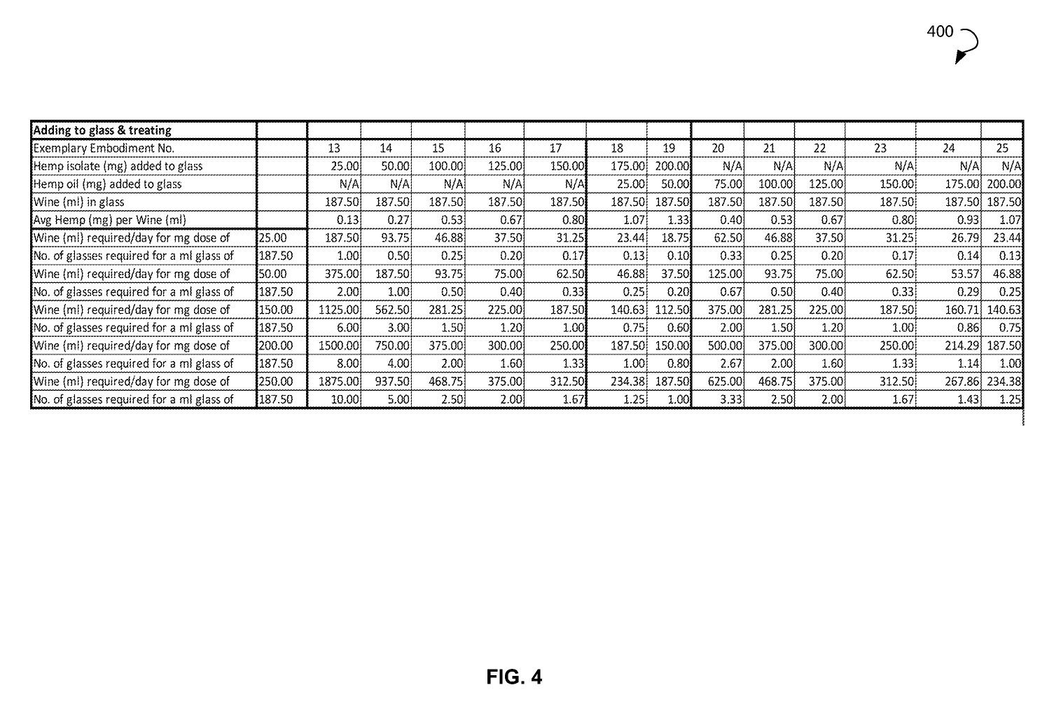

FIG. 4 is a table 400 showing a range of doses for adding hemp oil and hemp isolate to a glass of wine according to embodiments of the present technology. Table 400 of FIG. 4 shows ratios for precise amounts of hemp cannabidiol isolate (CBD isolate) added to each glass bottle in exact amounts (by weight) prior to the filling of each glass. Table 400 of FIG. 4 shows a volume of CBD wine that a consumer must drink to receive a desired CBD dose.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The flowchart and block diagrams in the Figures illustrate the architecture, functionality, and operation of possible implementations of systems, and methods according to various embodiments of the present technology. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for preparing blended beverages, the method comprising:
dissolving a cannabinoid oil into an ethanol based liquid, the ethanol based liquid being at least 95 percent Alcohol By Volume (ABV) to produce an emulsion of the cannabinoid oil in the at least 95 percent ABV ethanol; and
heating the emulsion of the cannabinoid oil in the at least 95 percent ABV ethanol to between 100 degrees Fahrenheit and 160 degrees Fahrenheit, the heating of the emulsion resulting in the cannabinoid oil dissolving in the at least 95 percent ABV ethanol.

2. The method of claim 1, wherein the cannabinoid oil is a hemp phytocannabinoid, the hemp phytocannabinoid occurring naturally in a hemp plant.

3. The method of claim 2, wherein the hemp phytocannabinoid is cannabidiol (CBD).

4. The method of claim 1 further comprising:
preparing the cannabinoid oil by refining a hemp plant using at least one of chromatographic separation, distillation, and selective membrane filtration.

5. The method of claim 1 further comprising:
preparing the cannabinoid oil by crude extraction from a hemp plant, the crude extraction from the hemp plant comprising removing plant material from the hemp plant.

6. The method of claim 1 further comprising:
high shear mixing of the emulsion of the cannabinoid oil dissolved in the at least 95 percent ABV ethanol based liquid.

7. The method of claim 6, wherein the high shear mixing comprises:
dispersing the emulsion of the cannabinoid oil in the at least 95 percent ABV ethanol using an array of rotors and stators to produce a dispersed emulsion of the cannabinoid oil in the at least 95 percent ABV ethanol.

8. The method of claim 6, further comprising:
sonicating the dispersed emulsion of the cannabinoid oil in the at least 95 percent ABV ethanol using an ultrasonic homogenizer; and
bubbling nitrogen gas into the dispersed emulsion of the cannabinoid oil in the at least 95 percent ABV ethanol, the bubbling of the nitrogen gas preventing oxygen degradation of the dispersed emulsion of the cannabinoid oil in the at least 95 percent ABV ethanol.

9. The method of claim 1 further comprising:
microfluidizer high shear fluid processing of the emulsion of the cannabinoid oil in the at least 95 percent ABV ethanol.

10. A method for preparing blended beverages, the method comprising:
heating a crystallized powder cannabinoid compound to at least 155 degrees Fahrenheit, the heating of the crystallized powder cannabinoid resulting in melting of the crystallized powder cannabinoid; and
dissolving the melted crystallized powder cannabinoid compound into an ethanol based liquid, the ethanol based liquid being at least 95 percent Alcohol By Volume (ABV) to produce a suspension of the melted crystallized powder cannabinoid compound in the at least 95 percent ABV ethanol.

11. The method of claim 10, wherein the crystallized powder cannabinoid compound is a hemp phytocannabinoid, the hemp phytocannabinoid occurring naturally in a hemp plant.

12. The method of claim 11, wherein the hemp phytocannabinoid is a cannabidiol (CBD) crystalline isolate.

13. The method of claim 10 further comprising:
high shear mixing of the suspension of the crystallized powder cannabinoid compound dissolved in the at least 95 percent ABV ethanol based liquid; and
bubbling nitrogen gas into the suspension of the crystallized powder cannabinoid compound dissolved in the at least 95 percent ABV ethanol based liquid, the bubbling of the nitrogen gas preventing oxygen degradation of the suspension of the crystallized powder cannabinoid compound dissolved in the at least 95 percent ABV ethanol based liquid.

14. The method of claim 13 wherein the high shear mixing comprises:
dispersing the suspension of the crystallized powder cannabinoid compound dissolved in the at least 95 percent ABV ethanol based liquid using an array of rotors and stators to produce a homogenized suspension of the crystallized powder cannabinoid compound in the at least 95 percent ABV ethanol.

15. The method of claim 14 further comprising:
adding the homogenized suspension of the crystallized powder cannabinoid compound in the at least 95 percent ABV ethanol to an alcoholic beverage.

16. The method of claim 15 wherein the alcoholic beverage is at least one of a wine, a spirit, and a beer.

17. The method of claim 15 wherein the alcoholic beverage is a concentration of at least 20 milligrams of the crystallized powder cannabinoid compound per cubic centimeter of the beverage.

18. The method of claim 15 wherein the alcoholic beverage is a concentration of at least 25 milligrams of the crystallized powder cannabinoid compound per cubic centimeter of the beverage.

19. A cannabinoid enriched alcoholic beverage, comprising:
a fermented alcoholic beverage with an ethyl alcohol content ranging between 2 percent Alcohol By Volume (ABV) and 20 percent ABV; and
cannabinoid being present a concentration between 00.01 milligrams (mg) per milliliter (mL) and 10.00 mg per mL.

20. The cannabinoid enriched alcoholic beverage of claim 19, wherein the cannabinoid is at least one of an acid form comprising Cannabigerolic acid (CBGA), Δ9-tetrahydrocannabinolic acid (THCA), Cannabidiolic acid (CBDA), Cannabichromenenic acid (CBCA), Cannabigerovarinic acid (CBGVA), Tetrahydrocanabivarinic acid (THCVA), Cannabidivarinic acid (CBDVA), and Cannabichromevarinic acid (CBCVA), and an decarboxylated form comprising Cannabigerol (CBG), Δ9-tetrahydrocannabinol (THC), Cannabidiol (CBD), Cannabichromene (CBC), Cannabigerivarin (CBGV), Tetrahydrocannabivarin (THCV), Cannabidivarin (CBDV), and Cannabichromevarin (CBCV).

21. The cannabinoid enriched alcoholic beverage of claim 20, wherein the fermented alcoholic beverage is at least one of beer, mead, cider, wine, port, and fortified wine.

22. The cannabinoid enriched alcoholic beverage of claim 19, wherein the cannabinoid is cannabidiol (CBD).

23. A cannabinoid enriched alcoholic beverage, comprising:
a distilled alcoholic beverage with an ethyl alcohol content ranging between 42 percent Alcohol By Volume (ABV) and 90 percent ABV; and
cannabinoid being present a concentration between 00.01 milligrams (mg) per milliliter (mL) and 10.00 mg per mL.

24. The cannabinoid enriched alcoholic beverage of claim 23, wherein the cannabinoid is at least one of an acid form comprising Cannabigerolic acid (CBGA), Δ9-tetrahydrocannabinolic acid (THCA), Cannabidiolic acid (CBDA), Cannabichromenenic acid (CBCA), Cannabigerovarinic acid (CBGVA), Tetrahydrocanabivarinic acid (THCVA), Cannabidivarinic acid (CBDVA), and Cannabichromevarinic acid (CBCVA), and an decarboxylated form comprising Cannabigerol (CBG), Δ9-tetrahydrocannabinol (THC), Cannabidiol (CBD), Cannabichromene (CBC), Cannabigerivarin (CBGV), Tetrahydrocannabivarin (THCV), Cannabidivarin (CBDV), and Cannabichromevarin (CBCV).

25. The cannabinoid enriched alcoholic beverage of claim 24, wherein, wherein the distilled alcoholic beverage is at least one of bourbon, whiskey, tequila, brandy, scotch, liqueur, absinthe, and moonshine.
